(19) United States
(12) Patent Application Publication
(10) Pub. No.: US 2006/0229079 A1
(43) Pub. Date: Oct. 12, 2006

(54) Method and device for radio resource allocation in multi-standard wireless communication systems

(76) Inventors: Jiang Cheng, Shanghai (CN); Ni Ma, Shanghai (CN); Xuejun Zhang, Shanghai (CN)

Correspondence Address: PHILIPS INTELLECTUAL PROPERTY & STANDARDS, P.O. BOX 3001, BRIARCLIFF MANOR, NY, 10510, US

(21) Appl. No.: 10/540,690

(22) PCT Filed: Dec. 18, 2003
(86) PCT No.: PCT/IB03/06128

§ 371 Date: Apr. 11, 2006

(30) Foreign Application Priority Data
Dec. 27, 2002 (CN) 02160404.5

(51) Int. Cl. H04Q 7/20

(52) U.S. Cl. 455/450; 455/552.1; 455/168.1; 455/509

(57) ABSTRACT

A wireless communication system, comprises a plurality of transceivers, receiving and transmitting RF signals (40); a plurality of RF processing units (60), processing said received signals or signals to be transmitted by said transceivers; RF resources allocator, detecting (90) information contained in received signals from a uplink on the types of different wireless communication schemes which are requested to access, and allocating (80) RF resources shared by said different wireless communications schemes according to said detected information.

### FIELD OF THE INVENTION

The present invention relates to multi-standards wireless communication systems; and, more particularly, to method and apparatus for allocating RF resources in multi-standard communication systems.

### BACKGROUND OF THE INVENTION

With the development of mobile communication systems, more and more communication standards (i.e. wireless communication schemes) came into emergence, e.g., GSM, IS-95 and CDMA, which belong to the second generation (2G) communication scheme, GPRS and TSM, which belong to the from-2G-to-3G communication scheme, TD-SCDMA, W-CDMA and cdma2000, which fall into the third generation (3G) communication scheme, and even WLAN, another popular wireless communication scheme, and etc.

According to the regulation of ITU, mobile communication systems with different wireless communication schemes are required to transmit data using carriers in different frequency bands. However, with the rapid development of communication services, various wireless communication schemes appeared, i.e. different wireless communication schemes may transmit data using different carriers within the same frequency band. Typically, TSM communication scheme proposed by CWTS (China Wireless Communication Standard group) shares the same frequency band with TD-SCDMA communication scheme.

TD-SCDMA is a TDD-mode communication scheme to transmit data with SCDMA (synchronous code division multiple access) technology, while TSM is designed as an evolving communication scheme from existing communication system with GSM communication scheme to the communication system with TD-SCDMA communication scheme. As an interim communication scheme, TSM communication scheme shares the same frequency band with TD-SCDMA communication scheme to transmit data.

When a communication system is evolving from TSM communication scheme to TD-SCDMA communication scheme, TSM subscribers and TD-SCDMA subscribers experience constant changes, i.e., in the prologue of the evolution, TSM subscribers account for the majority, with the evolution going along TSM subscribers decrease and TD-SCDMA subscribers increase gradually, and TSM subscribers only account for a minority while TD-SCDMA subscribers constitute the majority in the epilogue of the evolution. Distinct changes in the structure of TSM subscribers and TD-SCDMA subscribers require different frequency resources, therefore the limited frequency resources need to be allocated dynamically among co-existing wireless communication schemes, so as to achieve rational allocation and reuse of RFresources.

### SUMMARY OF THE INVENTION

It is, therefore, an object of the present invention to provide a method and an apparatus for allocating RF resources in multi-standard wireless communication systems, which capable of dynamically allocating limited RF resources to co-existing wireless communication schemes according to the requirements.

Another object of the invention is to provide a method and an apparatus for allocating RF resources in multi-standard wireless communication systems, which capable of statistically configuring the RF resources shared by co-existing wireless communication schemes to improve the utilization of spectrum, in the long evolving process.

Another object of the invention is to provide a method and an apparatus for allocating RF resources among multi-standard wireless communication systems, which capable of making expected configurations to the RF resources shared by co-existing wireless communication schemes to improve the utilization of spectrum, in the prologue and the epilogue of the evolution.

To meet the object above, a method for allocating RF resources among multi-standard wireless communication systems, as proposed in the present invention, comprising:

(a) detecting a plurality of received signals from a uplink, wherein said signals contain information on the types of the different wireless communication schemes which are requested to access; and

(b) allocating the radio RF resources shared by said different communications schemes according to said detected information.

To achieve the object above, an apparatus for allocating RF resources among multi-standard wireless communication systems, as proposed in the present invention, comprising:

a status detector, detecting a plurality of received signals from a uplink, wherein said signals contain information on the types of the different wireless communication schemes which are requested to access; and

a resource allocator, allocating the RF resources shared by said different communications schemes according to said detected information.

To attain the object above, a wireless communication system, as proposed in the present invention, comprising:

a plurality of transceivers, receiving and transmitting RF signals;

a plurality of RF processing units, processing said received signals or signals to be transmitted by said transceivers;

RF resources allocator, detecting the information contained in received signals from a uplink on the types of the different wireless communication schemes which are requested to access, and allocating RF resources shared by said different communications schemes according to said detected information.

### BRIEF DESCRIPTION OF THE DRAWINGS

Further description to the invention will be given below, in conjunction with the accompanying figures, wherein:

FIG. 1 diagrams the structure of a cellular communication system;

FIG. 2 depicts the structure of each cell of the cellular communication system in FIG. 1;

FIG. 3 illustrates the structure of a base station/node of each cell in FIG. 2;

FIG. 4 is the flow chart of the expected configuration method 1;

FIG. 5 is the flow chart of the expected configuration method 2;

### DETAILED DESCRIPTION OF THE PREFERRED EMBODIMENTS

This invention provides a method and an apparatus for dynamically allocating RF resources to co-existing wireless communication schemes in a base station, according to different requirements of the co-existing wireless communication schemes. In the following embodiments of a wireless communication system where TSM and TD-SCDMA wireless communication schemes co-exist, the method and apparatus have different characteristics when applied in said co-existing wireless communication schemes during different evolving phases.

Descriptions will respectively be presented, in conjunction with the accompanying drawings, to the method and apparatus for statistical configuration of the shared RF resources, as provided in the invention, during the evolving process, and the method and apparatus for expected configuration of the shared RF resources, as provided in the invention, during the prologue and the epilogue of the evolving process, in the communication system where TSM and TD-SCDMA wireless communication schemes co-exist.

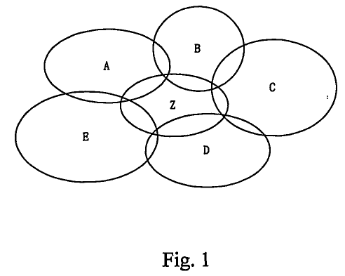

As shown in FIG. 1, A, B, C, D, E and Z represent 6 cells, which constitute a mobile communication system where cell Z is the center cell and cell A-E are adjacent cells of cell Z.

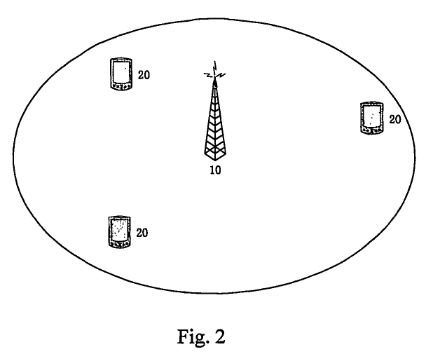

As shown in FIG. 2, every cell in FIG. 1 contains a base station 10 (namely Node B), and one or many mobile terminals 20.

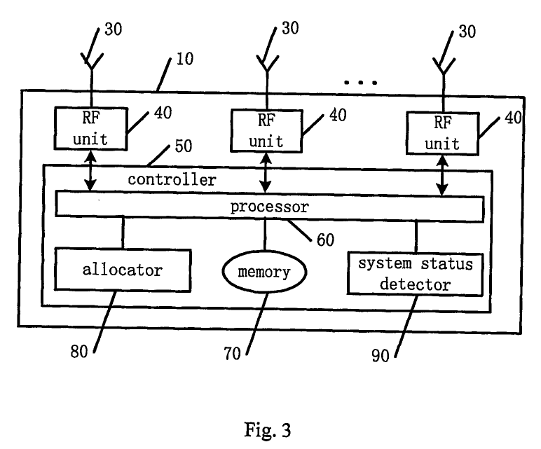

FIG. 3 demonstrates the structure of the base station 10 of a cell in FIG. 2. As shown in FIG. 3, the base station 10 includes N antennas 30 for receiving and transmitting RF signals, N RF units 40 and a controller 50, wherein:

Every RF unit 40 is composed of a transceiver, a modulator and a demodulator. An input/output of the transceiver is coupled to the corresponding antenna 30 to receive RF signals from antenna 30 or transmit RF signals via antenna 30, an output of the transceiver is coupled to an input of said demodulator to demodulate the received RF signals, and an input of the transceiver is coupled to the output of said modulator to send the modulated signals to antenna 30 for transmitting. Every RF unit 40 has its own RF carriers to transmit data.

Said controller 50 comprises a processor 60, an allocator 80, a memory 70 and a system status detector 90, wherein said processor 60 is coupled to another input/output of the transceiver in each said RF units 40, to receive signals from each RF units 40, at the same time said processor 60 communicates with allocator 80, memory 70 and system status detector 90, more particularly, status detector 90 detects the types of the wireless communication schemes which are requested to access, according to the signals from processor 60; when used to store information on RF resources allocation in multi-standard wireless communication systems, memory 70 is also used to record the number of the requests for accessing each of the wireless communication schemes detected by status detector 90 in a certain period, if the base station chooses the method of statistical configuration of RF resources; resource allocator 80 dynamically allocates RF resources shared by said TSM and TD-SCDMA wireless communication schemes, according to the number of the requests for accessing each of the different wireless communication schemes recorded by the memory in statistical configuration method, or according to the types of the wireless communication schemes detected by status detector 90 and the information on RF resources allocation stored in the memory; then processor 60 controls and adjusts the RF carriers in RF unit 40 according to instructions from resource allocator 80.

Detailed descriptions as follows will be respectively given to said statistical configuration method and expected configuration method, according to different evolving phases of TSM and TD-SCDMA communication schemes.

Statistical Configuration Method

Generally speaking, the evolution from TSM communication scheme to TD-SCDMA communication scheme is a long-term procedure, which could last several years. In this case, subscribers of the two wireless communication schemes won't change dramatically during the procedure, so the configuration of RF resources can be done at intervals, for example every other month.

Resource allocator 80 reallocates RF carriers in each cell according to the number of the requests for accessing each of TSM wireless communication scheme and the number for TD-SCDMA wireless communication scheme recorded by memory 70 within an interval, wherein the number recorded by memory 70 is the total traffic load number of each of the two wireless communication schemes within the whole interval. Before the next interval starts, memory 70 will be cleared to record the number of the requests for accessing each of TSM and TD-SCDMA wireless communication schemes detected by status detector 90 in the next interval.

Two embodiments will be offered to display the statistical configuration method, wherein allocator 80 dynamically allocates RF resources according to the number of the requests for accessing each of said wireless communication schemes.

### Embodiment 1

When needing to configure RF resources after an interval, allocator 80 first accesses memory 70 to inquire the number of the requests for accessing each of the two wireless communication schemes detected by status detector 90 within the interval, and calculates the ratio R of the number of the requests is for accessing TSM communication scheme to the number of the requests for accessing TD-SCDMA communication scheme. Afterwards, assumed that the number of RF carriers in a cell is N, allocator 80 allocates the number of carriers for TSM communication scheme as N1, and that of TD-SCDMA communication scheme as N2, where N1+N2=N, and calculates the value of N1/N2. Allocator 80 allocates several sets of N1 and N2 (N1 and N2 should be kept no less than 1 so as to guarantee the two wireless communication schemes accessible), and acquires the value of N1/N2 of every set of N1 and N2, and then according to the calculated ratio R, allocator 80 picks the value of N1/N2 which is closest to R, and allocates the N RF carriers to the two TSM and TD-SCDMA wireless communication schemes.

For example, the number is 3.4Erl for TSM wireless communication scheme and 8.5Erl for TD-SCDMA wireless communication scheme and N=8, then R=0.4. If 2 RF carriers are allocated to TSM wireless communication scheme and 6 to TD-SCDMA wireless communication scheme, it can be obtained that N1/N2=0.3333. If 3 RF carriers are allocated to TSM wireless communication scheme and 5 to TD-SCDMA wireless communication scheme, it can be gotten that N1/N2=0.6. As above, allocator 80 should choose the first RF carriers allocation, which is closer to R.

### Embodiment 2

In embodiment 1, allocator 80 uses the number of the requests for accessing each of TSM and TD-SCDMA wireless communication schemes within the whole interval to calculate the traffic ratio R. However, the most important data is the data from rush hour of the interval which is most related to the block rate, so in embodiment 2 a slight revision can be taken to embodiment 1, i.e. instead of the number of the requests within the whole interval, only the number of the requests from rush hour of the interval is used to calculate the ratio R, and others are the same as embodiment 1.

Expected Configuration Method

In the prologue of evolution, TD-SCDMA subscribers will be much fewer than TSM subscribers. In this case, it will be very inefficient if RF carriers for TD-SCDMA wireless communication scheme are still reserved in each cell. Embodiment 1 of the expected configuration method in this invention is introduced to solve this problem.

### Embodiment 1

According to the expected configuration method, all RF carriers in a cell will be allocated to TSM wireless communication scheme a RF carrier will be allocated to TD-SCDMA wireless communication scheme only in the following cases:

(1) A TD-SCDMA subscriber sends a connection request in the cell;

(2) A TD-SCDMA subscriber moves from an adjacent cell to the cell and sends a handover request in the cell.

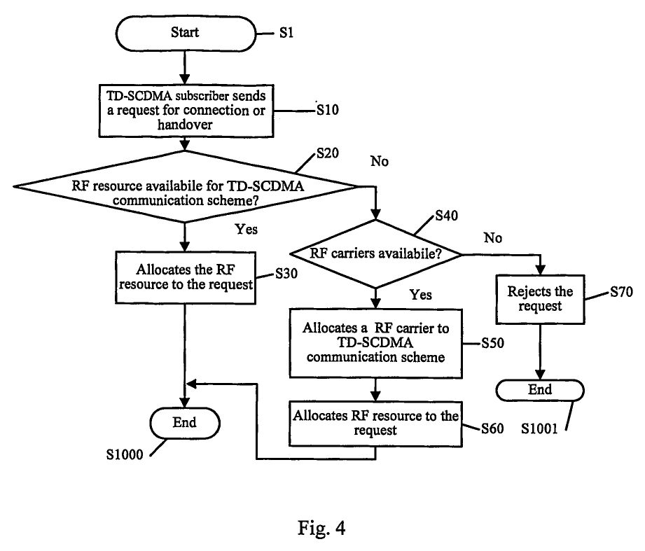

As the expected configuration method shown in FIG. 4, in a cell, when there is no connection from any TD-SCDMA subscriber, all RF carriers are allocated to TSM wireless communication scheme (S1). When a TD-SCDMA subscriber in the cell sends a request for connection or handover (S10), the base station in the cell will first judge whether there are RF resources available for TD-SCDMA wireless communication scheme (S20), the RF resources will be allocated to said request if there are RF resources available for TD-SCDMA wireless communication scheme (S30), if there are no RF resources available for TD-SCDMA wireless communication scheme, it will judge whether there are RF carriers available (S40), if there are RF carriers available, a RF carrier will be allocated to TD-SCDMA wireless communication scheme (S50) and then the RF resources corresponding to the RF carrier will be allocated to said request (S60), if there are no RF carriers available, the request will be rejected (S70) and the request will be terminated (S1001).

Once all communications of TD-SCDMA wireless communication scheme in the cell end, i.e. once there is no connection of TD-SCDMA wireless communication scheme in said cell, the RF carriers occupied by TD-SCDMA wireless communication scheme will be reallocated to TSM wireless communication scheme.

In the epilogue of evolution, the case reverses totally. Almost all subscribers are of TD-SCDMA wireless communication scheme, except for very few TSM subscribers. In this case, it can be very inefficient if RF carriers are still reserved for TSM communication in each cell. Embodiment 2 of the expected configuration method of this invention is introduced to solve this problem.

### Embodiment 2

According to said expected configuration method, all RF carriers in a cell will be allocated to TD-SCDMA wireless communication scheme except for the following cases where one RF carrier will be allocated to TSM wireless communication scheme:

(1) A TSM subscriber sends a connection request in the cell;

(2) A TSM subscriber moves from an adjacent cell to the cell and sends a handover request in the cell.

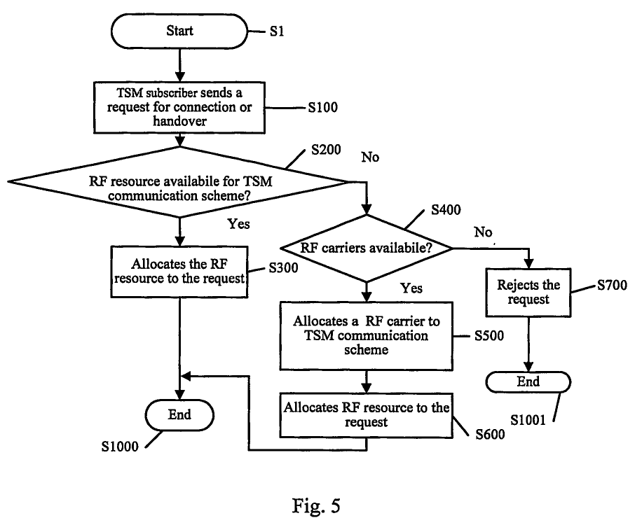

As the expected configuration method shown in FIG. 5, in a cell, when there is no connection from TSM subscribers, all RF carriers are allocated to TD-SCDMA wireless communication scheme (S1). When a TSM subscriber in the cell sends a request for connection or handover (S100), the base station in the cell will first judge whether there are RF resources available for TSM wireless communication scheme (S200), if there are RF resources available for TSM wireless communication scheme, the RF resources will be allocated to said request (S300), if there are no RF resources available for TSM wireless communication scheme, it will judge whether there are RF carriers available (S400), if there are RF carriers available, a RF carrier will be allocated to TSM wireless communication scheme (S500) and then the RF resources corresponding to the RF carrier will be allocated to said request (S600), if there are no RF carriers available, the request will be rejected (S700) and the request will be terminated (S1001).

Once all communications of TSM wireless communication scheme end (S1000), i.e. once there is no connection of TSM wireless communication scheme in the cell, the RF carriers occupied by TSM wireless communication scheme will be reallocated to TD-SCDMA wireless communication scheme.

In fact, we will designate the most of the RF carriers by statistical configuration method and reserve a few carriers for expected configuration method to accommodate the rapid variation of the number of subscribers in different wireless communication schemes.

Beneficial Use of the Invention

As to the method and apparatus provided by the present invention for allocating RF resources in multi-standard wireless communication systems, because the resource allocator of the apparatus can timely allocate RF resources shared by co-existing wireless communication schemes according to the number of the requests for accessing each of the different wireless communication schemes detected by the status detector, therefore, the method and apparatus can dynamically allocate limited RF resources to co-existing wireless communication schemes.

As to the method and apparatus provided by the present invention for allocating RF resources in multi-standard wireless communication systems, because the method and apparatus can employ statistical configuration method, expected configuration method, or their combination, according to different evolving phases of the communication system and different ratio of traffic requirements, accordingly, the method and apparatus can realize rational configuration of RF resources shared by co-existing wireless communication schemes, thus to increase the utilization of limited RF resources.

Of course, while the invention has been shown and described with respect to the preferred embodiment, it will be understood by those skilled in the art that the RF resource allocation method for multi-standard wireless communication systems provided in this invention may not be limited to the communication system with TSM or TD-SCDMA communication scheme, but also applicable to the communication systems with other wireless communication schemes.

It will also be understood by those skilled in the art that various improvements can be made to the RF resource allocation method for multi-standard wireless communication systems released in this invention. Therefore, the scope of the invention to be protected needs to be determined by what is claimed.

1. A method for radio RF resources allocation in multi-standard wireless communication systems, comprising:
(a) detecting a plurality of received signals from a uplink, wherein said signals contain information on the types of the different wireless communication schemes which are requested to access; and
(b) allocating the radio RF resources shared by said different communications schemes according to said detected information.

2. The method of claim 1, wherein step (b) further includes:
(b1) carrying out a statistic of the information on the requests for accessing each of said different wireless communication schemes in a set interval; and
(b2) allocating said RF resources shared by said different wireless communication schemes according to said statistic of the set interval.

3. The method of claim 2, wherein said information on the requests for accessing each of said different wireless communication schemes includes the number of the requests for accessing each of said different wireless communication schemes.

4. The method of claim 3, wherein in step (b2), the allocation of said RF resources is realized by calculating the ratio of the number of the requests for accessing each of said different wireless communication schemes.

5. The method of claim 2, wherein in step (b1), said statistic is achieved by carrying out a statistic of said information on the requests for accessing each of said different wireless communication schemes within the set whole interval.

6. The method of claim 2, wherein in step (b1), said statistic is achieved by carrying out a statistic of said information on the requests for accessing each of said different wireless communication schemes within rush hours of the set interval.

7. The method of claim 1, wherein step (b) further includes:
(b2) judging whether there are RF resources available for the requests for accessing said different wireless communication schemes; and
(b3) allocating said available RF resources to said requests, if there are RF resources available for said requests.

8. The method of claim 1, wherein step (b) further includes:
(b1) pre-allocating said RF resources to a specific communication scheme;
(b2) judging whether there are RF resources available for the requests for accessing the different wireless communication schemes, if the different wireless communication schemes are not the specific communication scheme; and
(b3) allocating said available RF resources to said requests, if there are RF resources available for said requests.

9. The method of claim 7, wherein step (b2) and (b3) are executed in following condition:
subscribers send said connection requests for accessing said different wireless communication schemes.

10. The method of claim 7, wherein step (b2) and (b3) are executed in following condition:
subscribers which carry out cell handover send said handover requests for accessing said different wireless communication schemes.

11. The method of claim 7, wherein step (b3) further includes:
(i) judging whether there are RF carrier available for said requests, if there are no RF resources available for said requests for accessing said wireless communication schemes; and
(ii) allocating said available RF carrier to said wireless communication schemes, if there are RF carriers available for said requests, and allocating the corresponding RF resources to said requests.

12. The method of claim 11, wherein step (ii) further includes:
when the communications employing said wireless communication schemes ends, said RF carriers allocated to said requests are released.

13. The method of claim 11, wherein step (ii) further includes:
if there are no RF carriers available for said requests, said requests are rejected.

14. The method of claim 1, said wireless communication schemes include at least two of following: IS-95, CDMA, GSM, TSM, GPRS, TD-SCDMA, W-CDMA cdma 2000 and WLAN.

15. A device for RF resources allocation in multi-standard wireless communication systems, comprising:
a status detector, detecting a plurality of received signals from a uplink, wherein said signals contain information on the types of the different wireless communication schemes which are requested to access; and
a resource allocator, allocating the RF resources shared by said different communications schemes according to said detected information.

16. The device of claim 15, wherein said resource allocator allocates said RF resources according to a statistic of the information on the requests for accessing each of said different communications schemes in a set interval.

17. The device of claim 16, wherein said information on the requests for accessing each of said different communications schemes includes the number of the requests for accessing each of said different communications schemes.

18. The device of claim 17, wherein said resource allocator realizes said RF resources allocation by calculating the ratio of the number of the requests for accessing each of said different wireless communication schemes.

19. The device of claim 16, wherein said statistic is achieved by carrying out a statistic of said information on the requests for accessing each of said different wireless communication schemes within the set whole interval.

20. The device of claim 16, wherein, said statistic is achieved by carrying out a statistic of said information on requests for accessing each of said different wireless communication schemes within rush hours of the set interval.

21. The device of claim 15, wherein said RF resources allocation executed by said resource allocator includes:
(b) judging whether there are RF resources available for the requests for accessing said different wireless communication schemes; and
(c) allocating said available RF resources to said requests, if there are RF resources available for said requests.

22. The device of claim 15, wherein said RF resources allocation executed by said resource allocator includes:
(a) pre-allocating said RF resources to a specific communication scheme;
(b) judging whether there are RF resources available for the requests for accessing the different wireless communication schemes, if the different wireless communication schemes are not the specific communication scheme; and
(c) allocating said available RF resources to said requests, if there are RF resources available for said requests.

23. The device of claim 21, wherein step (b) and (c) are executed in following condition:
subscribers send said connection requests for accessing the different wireless communication schemes.

24. The device of claim 21, wherein step (b) and (c) are executed in following condition:
subscribers which carry out cell handover send said handover requests for accessing the different wireless communication schemes.

25. The device of claim 21, wherein said RF resources allocation executed by said resource allocator includes:
judging whether there are RF carriers available for said requests for accessing the different wireless communication schemes, if there are no RF resources available for said requests; and
allocating said available RF carriers to the different wireless communication schemes, if there are RF carriers available for said requests, and allocating the corresponding RF resources to said requests.

26. The device of claim 25, wherein said RF resources allocation executed by said resource allocator includes:
when the communications employing said different wireless communication schemes end, said RF carriers allocated to said requests are released.

27. The device of claim 25, wherein said RF resources allocation executed by said resources allocator includes:
if there are no RF carriers available for said requests, said requests are rejected.

28. The device of claim 15, said different wireless communication schemes include at least two of following: IS-95, CDMA, GSM, TSM, GPRS, TD-SCDMA, W-CDMA, cdma 2000 and WLAN.

29. A wireless communication system, comprising:
a plurality of transceivers, receiving and transmitting RF signals;
a plurality of RF processing units, processing said received signals or signals to be transmitted by said transceivers;
RF resources allocator, detecting the information contained in received signals from a uplink on the types of the different wireless communication schemes which are requested to access, and allocating RF resources shared by said different communications schemes according to said detected information.

30. The system of claim 29, wherein said RF resources allocator allocates said RF resources according to a statistic of the information on the requests for accessing each of said different wireless communication schemes within a set interval.

31. The system of claim 30, wherein said information on the requests for accessing each of said different wireless communication schemes includes the number of the requests for accessing each of said different wireless communication schemes.

32. The system of claim 31, wherein said RF resources allocator realizes said RF resources allocation by calculating the ratio of the number of the requests for accessing each of said different wireless communication schemes.

33. The system of claim 30, wherein said statistic is achieved by carrying out a statistic of said information on the requests for accessing each of said different wireless communication schemes within the set whole interval.

34. The system of claim 30, wherein, said statistic is achieved by carrying out a statistic of said information on the requests for accessing each of said different wireless communication schemes within rush hours of the set interval.

35. The system of claim 29, wherein said RF resources allocation executed by said RF resources allocator includes:
(b) judging whether there are RF resources available for the requests for accessing said different wireless communication schemes; and
(c) allocating said available RF resources to said requests, if there are RF resources available for said requests.

36. The system of claim 29, wherein said RF resources allocation executed by said RF resources resources allocator includes:
(a) pre-allocating said RF resources to a specific communication scheme;
(b) judging whether there are RF resources available for the requests for accessing the different wireless communication schemes, if the different wireless communication schemes are not the specific communication scheme; and
(c) allocating said available RF resources to said requests, if there are RF resources available for said requests.

37. The system of claim 35, wherein step (b) and (c) are executed in following condition:
subscribers send said connection requests for accessing the different wireless communication schemes.

38. The system of claim 35, wherein step (b) and (c) are executed in following condition:
subscribers which carry out cell handover send said handover requests for accessing the different wireless communication schemes.

39. The system of claim 35, wherein said RF resources allocation executed by said RF resources allocator includes:
judging whether there are RF carriers available for said requests for accessing the different wireless communication schemes, if there are no RF resources available for said requests; and
allocating said available RF carriers to the different wireless communication schemes, if there are RF carriers available for said requests, and allocating the corresponding RF resources to said requests.

40. The system of claim 39, wherein said RF resources allocation executed by said RF resources allocator includes:
when the communications employing said different wireless communication schemes end, said RF carriers allocated to said requests are released.

41. The system of claim 39, wherein said RF resources allocation executed by said RF resources allocator includes:
if there are no RF carriers available for said requests, said requests are rejected.

42. The system of claim 39, said different wireless communication schemes include at least two of following: IS-95, CDMA, GSM, TSM, GPRS, TD-SCDMA, W-CDMA, cdma 2000 and WLAN.
